(19) United States
(12) Patent Application Publication
(10) Pub. No.: US 2004/0123317 A1
(43) Pub. Date: Jun. 24, 2004

(54) System and method for delivering electronic program guide

(75) Inventor: Toshiro Ozawa, San Diego, CA (US)

Correspondence Address: ROGITZ & ASSOCIATES, Suite 3120, 750 B Street, San Diego, CA, 92101, US

(73) Assignees: SONY CORPORATION, Tokyo (JP); SONY ELECTRONICS INC., Park Ridge, NJ (US)

(21) Appl. No.: 10/366,027

(22) Filed: Feb. 13, 2003

Related U.S. Application Data
(60) Provisional application No. 60/434,866, filed on Dec. 19, 2002.

(51) Int. Cl. G06F 13/00; H04N 5/445; G06F 3/00

(52) U.S. Cl. 725/39; 725/40; 725/43

(57) ABSTRACT

To reduce the storage requirements for a television electronic program guide (EPG), a single program information dataset can be referenced by many schedule information datasets for programs that are repeatedly broadcast. Also, to reduce bandwidth and storage requirements, to periodically refresh an EPG only the new day's dataset and changes to the existing EPG (“patches”) are sent. Further, the EPG can be downloaded from a service provider computer on demand to conserve broadcast bandwidth.

### RELATED APPLICATIONS

This application claims priority from U.S. provisional patent application serial No. 60/434,866, filed Dec. 19, 2002.

### I. FIELD OF THE INVENTION

The present invention relates generally to television systems.

### II. BACKGROUND OF THE INVENTION

Electronic program guides (EPG) are channel lists that are stored in, e.g., the memories of set-top boxes (STB) and that appear on TV screens to assist viewers in selecting a desired program. Typically, an EPG lists channels (and perhaps the network associated with that channel in a given area) in sequence in the first column of what essentially is a table, with the remaining columns establishing a schedule of programs for an extended period (e.g., fourteen days) for each listed channel. A data package for an entire EPG (or as much of it as the STB memory can handle) usually is downloaded from a service provider to an STB when the STB powers up after being deenergized.

In any case, EPG information can be thought of as having two components: a program information component, and a schedule information component. The program information can include the title of a program, detailed description of a program, rating values, available languages in the audio tracks, and other information. The schedule information, in contrast, is much smaller. It simply sets forth program start time, duration, and perhaps pricing and subscription information for pay-per-view channels.

With the above in mind, it will readily be appreciated that with advent of many channels, particularly satellite channels, EPG data may become very large. A fourteen day EPG data package listing 500 channels can consume ten megabytes of storage. This can exceed the capacity of the STB memory, so that an STB might be able to accept only a fraction of the EPG information. The remainder of the EPG information must be downloaded on the fly when a user requests information from the as-yet received EPG information portion, causing delays to the user.

Moreover, with large EPGs, not only a large amount of storage space is needed in the STB memory, but the limited bandwidth typically allocated to transmit the EPG information can result in long delays in receiving the EPG information upon power up of the STB. Having recognized these problems, the solutions below are provided to one or more of them.

### SUMMARY OF THE INVENTION

A television system can include a memory containing electronic program guide (EPG) information that in turn includes schedule information and program information. One and only one program information dataset is stored for a first program scheduled for transmission during at least first and second time periods. A processor displays an EPG at least in part by associating, for the first and second time periods, the first program with the one and only one program information dataset.

In a preferred embodiment, the schedule information is stored in a first data structure and the program information is stored in a second data structure referenced by the first data structure. The schedule information can represent channel numbers and time periods and the program information can represent at least program descriptions.

In another aspect, a method for providing an electronic program guide (EPG) for a television includes listing at least one program as being transmitted at least two separate viewing times, and storing one and only program information dataset associated with the program. Using the one and only one program information dataset, program information pertaining to each viewing time can be presented.

In still another aspect, a television system includes source means for transmitting television programs, with at least a first television program being transmitted at first and second times at least. Television means receive the programs, while memory means stores schedule information listing the first and second times. The memory means also stores program information including one and only one dataset pertaining to the first and second times.

In another aspect, a TV system includes a memory containing electronic program guide (EPG) information and a processor periodically updating the EPG information using at least one patch, with a patch being less than a full EPG dataset. A non-limiting patch may be established by an EPG dataset for one new increment and/or an update to an existing increment.

In yet another aspect, a method for updating EPG information stored in a television memory when the EPG includes information for plural current increments includes periodically sending to the TV a new increment and/or updates, if any, to current increments.

In still another aspect, a system includes EPG source means for transmitting, at periodic intervals, at least a new EPG portion and updates to current EPG portions, and television means including memory means for storing EPG information.

In another aspect, a television system includes a memory configured for containing electronic program guide (EPG) information, and a processor coupled to the memory and communicating with a service provider computer using TCP/IP for downloading EPG information therefrom on demand.

In yet another aspect, a method for providing EPG information to a television memory includes downloading on demand the EPG information to the memory from a computer using Internet Protocol.

In still another aspect, a system includes EPG information source means, television memory means, and processor means for causing EPG information to be conveyed to the memory means on user demand from the source means using a computer network.

In another aspect, a method for providing EPG information to a television system includes packing at least portions of the EPG information into a file and compressing the file to render a compressed file. The method also includes transmitting the compressed file to the television system.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is an architectural block diagram of the present system;

FIG. 2 is a schematic diagram of an EPG showing a schedule information data structure and a separate program information data structure;

FIG. 3 is a flow chart of the logic for establishing and using the schedule information portion and program information portions;

FIG. 4 is a flow chart of the logic for “patch” EPG refresh; and

FIG. 5 is a flow chart of the logic for downloading an EPG on demand from a computer.

### DETAILED DESCRIPTION OF THE PREFERRED EMBODIMENT

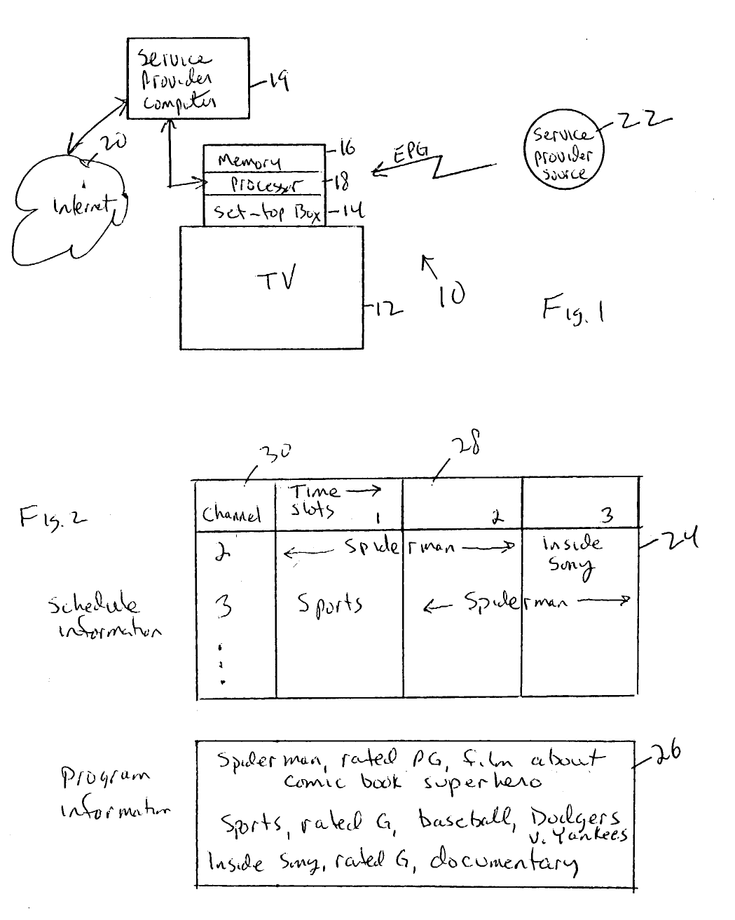

Referring initially to FIG. 1, a system is shown, generally designated 10, that includes a television 12 and associated set-top box (STB) 14. A memory 16, such as a solid state memory or disk memory or other memory, and a processor 18 can be included in the STB 14, although the memory 16 and processor 18 can be incorporated into the TV 12 if desired. In a preferred implementation the processor 18 may communicate with a service provider computer 19 over a TCP/IP connection and with a television service provider source 22, e.g., a satellite and/or cable and/or terrestrial broadcast antenna. The service provider computer 19 and, in come instances, the processor 18 may communicate with the Internet 20.

As set forth herein, electronic program guide (EPG) information can be provided from the source 22 (and in some instances from a service provider computer that may be connected to the Internet 20) and stored in the memory 16. The processor 18 can cause an EPG to be displayed on the TV 12 using the EPG information.

In one inventive aspect, referring to FIG. 2, the EPG information may be divided or separated into schedule information and program information. The schedule information may be stored in a schedule information data structure 24, such as a table or list, and the program information may be stored in a program information data structure 26. As shown, the schedule information may include time slots or intervals 28 and a column 30 listing available channels. For each time slot 28 and channel, a program reference, such as but not limited the name or other identification of the program to be transmitted in that slot, is provided. Subscription information may also be provided in the schedule information. The program information, on the other hand, includes information relating to the content of the programs, such as program summaries, rating values, available languages in the audio tracks, and other information.

In accordance with the present invention, the program references for a single program, although potentially transmitted plural times on the same or different channels, all reference one and only one information data set in the program information data structure 26. Thus, for example, “Spiderman” is transmitted in time slots 1 and 2 on channel 2 and in time slots 2 and 3 in channel 3, but both references to “Spiderman” in the schedule information data structure 24 reference one and only one dataset in the program information data structure 26. Accordingly, superfluous storage of repetitive program information is avoided. When a user desires to display the EPG, the processor 18 uses the schedule data structure 24 to set up the EPG, and then uses the references in the schedule information to retrieve the appropriate program information datasets for the various displayed programs on the EPG from the program information data structure 26.

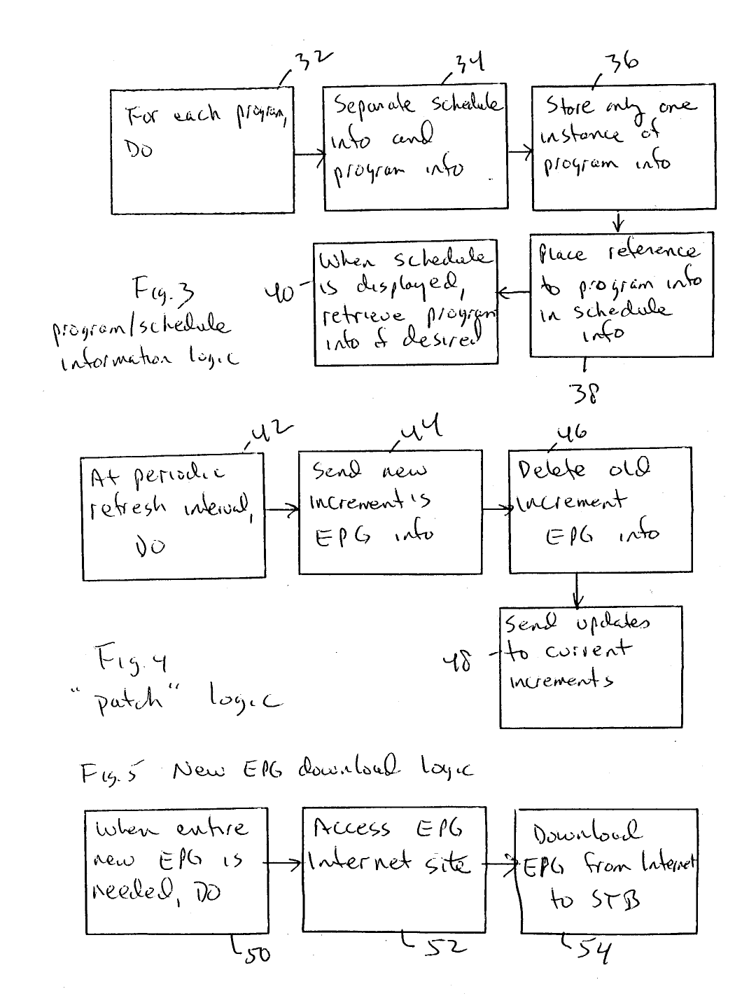

FIG. 3 shows non-limiting logic that can be used to implement the above invention. Commencing at block 32, for each program, the logic moves to block 34 to separate the schedule information from the program information. At block 36, one and only one instance of a program information dataset for each program is stored, regardless of how many times the program itself appears in the schedule information. Moving to block 38, a reference to the appropriate dataset is placed in the schedule information data structure for each program to be aired. At block 40, when the EPG is displayed, the program information datasets associated with the displayed schedule are retrieved and displayed on the EPG as desired by the user.

FIG. 4 shows that in addition to the above features, to further minimize the amount of EPG information that must be passed to television memories, the entire EPG need not be periodically refreshed. Rather, beginning at block 42, at periodic refresh intervals, e.g., daily, the logic can move to block 44 to send only the new increment's EPG information to the television 12. It is to be understood that an EPG contains information for many increments, e.g., if an increment is a day, an EPG might contain fourteen days of information. Thus, when the refresh interval is one increment, the new (latest) day's worth of EPG information is sent.

Also, the oldest EPG increment can be deleted at block 46 if desired. The result of blocks 44 and 46 together is that a rolling fourteen day (or other length) EPG is generated, with the oldest increment being deleted and a new one added on a periodic basis. Moreover, at block 48 updates to current increments (i.e., those increments that exist between the oldest increment deleted at block 46 and the just-downloaded new increment) are sent. In this way, only changes (“patches”) to the EPG need be transmitted, instead of the entire EPG itself on a periodic basis.

The present invention further recognizes that EPG transfer need not consume program transmission bandwidth. To this end, the logic of FIG. 5 is provided. Commencing at block 50, when, e.g., an entire new EPG dataset is required by the television 12 (for instance, upon initialization such as power up or boot up of the STB 14), the logic moves to block 52. At block 52, the processor 18 accesses an EPG information computer, for example the service provider computer 19, which may be on the Internet 20. Proceeding to block 54, the EPG information for the particular area in which the TV 12 is located can be downloaded on demand to the memory 16 over, e.g., a high speed Internet connection (TCP/IP) using hypertext transfer protocol (HTTP) or FTP or other appropriate protocol. This is in contrast to a broadcast, MPEG-type connection and is more efficient particularly when the data is not requested simultaneously by many STBs, e.g., when a single STB boots up. In this way, a user can obtain EPG information on demand to, e.g., boot up a set top box or to access future information on an obscure channel that might not otherwise be available.

If desired, the program information, which consists mostly of text, can be compressed in accordance with compression principles such as Huffman coding or Lempel-Zev. Data compression works better when the size of the original data block is relatively bigger. Accordingly, when the entire EPG is downloaded via, e.g., a service provider computer, it can be packed into a file and then compressed.

While the particular SYSTEM AND METHOD FOR DELIVERING ELECTRONIC PROGRAM GUIDE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconciliable with the present specification and file history.

I Claim:

What is claimed is:

1. A system, comprising:
a television;
at least one memory coupled to the television, the memory containing electronic program guide (EPG) information including schedule information and program information, one and only one program information dataset being stored for a first program scheduled for transmission during at least first and second time periods; and
at least one processor coupled to the memory for displaying an EPG at least in part by associating, with the first and second time periods, the one and only one program information dataset.

2. The system of claim 1, wherein the schedule information is stored in a first data structure and the program information is stored in a second data structure referenced by the first data structure.

3. The system of claim 1, wherein the schedule information represents at least channel numbers and time periods and the program information represents at least program descriptions.

4. A method for providing an electronic program guide (EPG) for a television, comprising:
listing at least one program as being transmitted at least two separate viewing times; and
storing one and only program information dataset associated with the program;
using the one and only one program information dataset, presenting program information pertaining to each viewing time.

5. The method of claim 4, comprising storing schedule information in a first data structure and program information in a second data structure referenced by the first data structure.

6. The method of claim 5, wherein the schedule information represents at least channel numbers and time periods and the program information represents at least program descriptions.

7. A television system, comprising:
source means for transmitting television programs, at least a first television program being transmitted at first and second times at least;
television means for receiving the programs; and
memory means for storing schedule information listing the first and second times, the memory means also storing program information including one and only one dataset pertaining to the first and second times.

8. The system of claim 7, wherein the television means displays an electronic program guide (EPG) at least in part by associating the first and second times with the dataset.

9. A system, comprising:
a television;
at least one memory coupled to the television, the memory containing electronic program guide (EPG) information; and
at least one processor periodically updating the EPG information using at least one patch, a patch being less than a full EPG.

10. The system of claim 9, wherein a full EPG includes plural temporal increments, and a patch is established by at least an EPG dataset for one new increment.

11. The system of claim 9, wherein a full EPG includes plural temporal increments, and a patch is established by at least one update to an existing increment.

12. The system of claim 10, wherein a patch is established by at least one update to an existing increment.

13. A method for updating an EPG stored in a television memory, the EPG including information for plural current increments, comprising:
periodically sending at least one of: a new increment and updates, if any, to current increments, to the television.

14. The method of claim 13, comprising sending both a new increment and updates, if any, to current increments.

15. The method of claim 14, further comprising deleting from memory an oldest current increment.

16. A system, comprising:
EPG source means for transmitting, at periodic intervals, at least a new EPG portion and updates to current EPG portions; and
television means including memory means for storing EPG information.

17. A system, comprising:
a television;
at least one memory coupled to the television, the memory configured for containing electronic program guide (EPG) information; and
at least one processor coupled to the memory and communicating using TCP/IP with a computer for downloading on demand of the processor EPG information therefrom.

18. The system of claim 17, wherein the processor is programmed to access an EPG information source site on the Internet.

19. The system of claim 17, wherein an entire EPG is downloaded to the memory from the Internet only upon initialization of the memory.

20. A method for providing EPG information to a television memory, comprising:
downloading the EPG information to the memory on demand using at least one Internet Protocol (IP).

21. The method of claim 20, wherein an entire EPG dataset is downloaded to the memory on demand upon initialization of the memory.

22. A system, comprising:
EPG information source means;
television memory means; and
processor means for demanding EPG information to be conveyed to the memory means from the source means.

23. The system of claim 17, further comprising compressing at least text portions of the EPG information.

24. The method of claim 20, further comprising compressing at least text portions of the EPG information.

25. The system of claim 22, further comprising means for compressing at least text portions of the EPG information.

26. A method for providing EPG information to a television system, comprising:
packing at least portions of the EPG information into at least one file;
compressing the file to render a compressed file; and
transmitting the compressed file to the television system.
